(19) United States
(12) Patent Application Publication
(10) Pub. No.: US 2006/0196119 A1
(43) Pub. Date: Sep. 7, 2006

(54) Light barrier holder

(76) Inventor: Michael Hormann, Oerlinghausen (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/329,367

(22) Filed: Jan. 9, 2006

(30) Foreign Application Priority Data
Jan. 10, 2005 (DE) 20 2005 000 270.4

(51) Int. Cl. E05F 15/10

(52) U.S. Cl. 49/26

(57) ABSTRACT

The present disclosure relates to a light barrier holder comprising a receiving housing for the receiving of a part of the light barrier, for example of a transmitter or of a receiver having an opening through which the rays of the light barrier can pass, with the surface of the housing being spherically arched in the region of the opening and wherein a tubular neck is set at the housing in the region of the opening and can be plugged through corresponding openings of installation openings each having a corresponding spherical arching and can be fixed in place by a securing element.

### CROSS REFERENCE TO RELATED APPLICATION

This application claims priority to German Patent Application Serial No. 20 2005 000 270.4 filed Jan. 10, 2005, which is hereby incorporated by reference in its entirety for all purposes.

### FIELD

The present disclosure relates to a light barrier holder such as is in particular used with drive-past light barriers for automatic garage doors.

### BACKGROUND AND SUMMARY

Drive-past light barriers of this kind are used as sensors as security on dangerous movements at doors. Drive-past light barriers of this type typically consist of a light barrier transmitter and a light barrier receiver which are, for example, arranged at both sides at the garage door to thus detect a vehicle driving past. Light barriers of this type are typically installed using assembly brackets. They can, however, also be installed in door posts, in concealed boxes or in boxes mounted on the plaster.

On the installation of the respective parts of the light barrier, that is of the transmitter and of the receiver, on oppositely disposed sides, it is frequently found to be difficult to align the respective parts accurately to one another.

It is therefore the object of the present disclosure to provide a light barrier holder which permits a simple adjustment of the light barrier parts on installation.

This object is solved in accordance with a light barrier holder comprising a receiving housing for the reception of a part of the light barrier, for example of a transmitter or of a receiver having an opening through which the rays of the light barrier can pass. In accordance with the present disclosure, the surface of the housing is arched in the manner of a spherical surface in the region of the opening, with a tubular neck being set at the housing in the region of the opening, said neck being able to be plugged through corresponding openings of installation elements each having a corresponding spherical arching and being able to be fixed by a securing element. While utilizing this spherical geometry, an adjustment and installation of the transmitter and the receiver to one another is possible in a simple manner. The receiving housing can be pivoted with respect to the installation elements due to the spherical geometry before being secured by means of the securing element or after the release of the securing element. Once the desired position has been reached, the position can then be fixed.

Further advantageous aspects of the present disclosure may also result.

For example, the tubular neck can accordingly have an external thread. The securing element is made as a fastening nut which can be screwed onto the external thread of the tubular neck. A simple installation or release of the connection is thereby possible.

Advantageously, all individual parts are comprised of plastic.

The installation elements may include disk-like or plate-like elements. Two installation elements are advantageously present which very particularly advantageously can be plugged into one another and clipped to one another so that an installation in a corresponding receiving opening is possible, for example of an installation bracket or of a doorpost or the like. In this embodiment, the disk-like or plate-like elements are set at both sides of the installation opening of the installation bracket or door post and are clipped together. The corresponding receiving housing is then pushed into these pre-installed installation elements and fixed via the securing element.

The installation elements are particularly advantageously arranged at both sides of an elongate cut-out, for example of an installation bracket. Not only a pivoting of the light barrier holder is thereby possible to adjust and align the transmitter and receiver to one another, but also a longitudinal displacement along the elongate cut-out.

Instead of the provision of separate installation elements, the installation element with the spherical arching shape matched to the spherical surface shape of the receiving housing can be part of an otherwise commercially available installation housing. The installation element can alternatively also be made with a matched spherical arching shape with a corresponding cut-out as part of a door pillar or of another element.

### BRIEF DESCRIPTION OF THE FIGURES

Further features, details and advantages of the present disclosure result from an embodiment shown in the drawing. There are shown:

FIG. 1 is an overview of a drive-past light barrier in an installation situation inside the garage;

FIGS. 2 a, b show the installation situation of the installation brackets at a side frame of a garage door during the installation; and

FIGS. 3 a, b show an alternative installation of the installation brackets of FIGS. 2 a, b.

### DETAILED DESCRIPTION

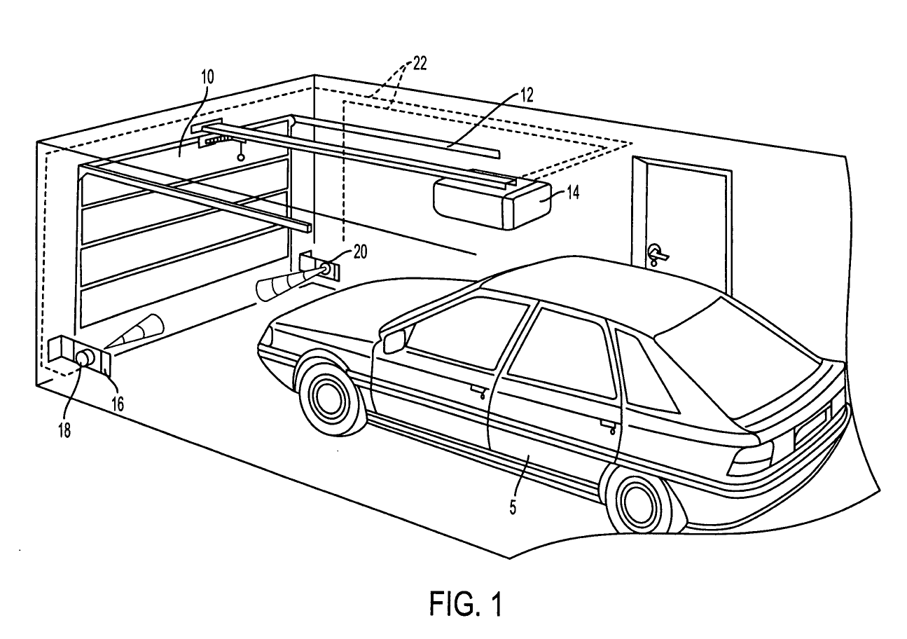

In FIG. 1, the interior space of a garage is shown schematically in which an automatic sectional garage door 10 guided in running rails 12 can be opened and closed via a garage door drive 14. Systems of this type are generally known so that a detailed representation can be omitted. The sectional garage door 10 is shown in a closed position here. Two parts of a light barrier, namely a light barrier transmitter 18 and a light barrier receiver 20 are arranged next to the sectional garage door 10 by means of two installation brackets 16 of identical design. Both the light barrier transmitter 18 and the light barrier receiver 20 are connected to the garage door drive 14 via leads 22 so that corresponding signals can be communicated to the garage door drive on the sensing of an object, for example of an automobile 5.

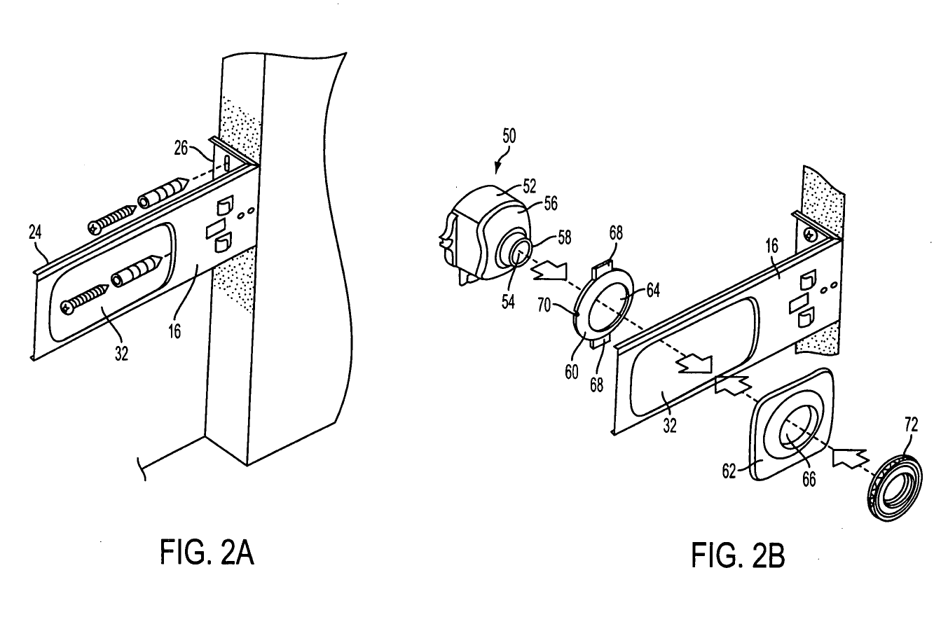

In FIG. 2, the structure of the installation bracket 16 is first shown in detail in FIG. 2 a. The installation bracket 16 includes a chamfered cut panel having two webs 24 and 26. The angle included by both webs 24 and 26 amounts to approximately 90° so that the shape of an L results overall. The installation bracket 16 has an elongate rectangular opening 32 into which the light barrier holder 50 for the transmitter or receiver of the light barrier can be received and also positioned in length by a corresponding displacement of the light barrier holder 50.

The design of the light barrier holder 50 in particular results from the exploded representation in FIG. 2 b. The light barrier holder 50 first includes a housing 52 in which respective parts of the light barrier, for example of a transmitter or of a receiver, are inserted in a manner not shown in any more detail. The rays of the light barriers exit through an opening 54. The surface 56 of the housing in the region of the opening 54 is arched spherically and a tubular neck 58 is set on the housing in the region of the opening. The tubular neck 58 has an external thread.

Installation elements 60 and 62 are arranged at both sides of the elongate cut-out 32 of the installation bracket 16 in FIG. 2 b. Both installation elements 60 and 62 each have large openings 64 and 66 in comparison with the external diameter of the tubular neck 58. The respective installation elements are likewise partly or fully spherically shaped, with the surface arching corresponding to the spherical surface 56 of the receiving housing 52. The two installation elements 60 and 62 are realized in the embodiment variant shown here such that they can be clipped together in the region of the elongate cut-out 32 after mounting on both sides on the installation bracket 16.

The installation element 60 is made as a plastic injection molded part which is of substantially annular design, with the ring having the previously described spherical shape respectively at its inner and outer surfaces. The outer diameter of the ring 60 substantially corresponds to the width of the cut-out 32 of the installation bracket 16. Two necks 68 are shaped on the annular main part of the installation element 60 and engage over the cut-out 32 and support the installation element 60 at one side at the rail 60. Two small cut-outs 70 are made at the side at the installation element 60 and can engage into corresponding projections in the installation element 62 and thereby permit a clipping or clamping of the two installation elements 60 and 62. After a corresponding installation of the installation elements 60 and 62 and in a mutual clipping or clamping, they can be displaced along the elongate cut-out 32 in the installation bracket 16 so that a longitudinal displacement of the light barrier holder 50 and thus also of the light barrier parts is made possible.

After a corresponding pre-installation of the installation elements 60 and 62, the receiving housing 50 with its tubular neck 58 can be pushed through the openings 64 and 66 of the installation elements 60 and 62 and can be fixed in place after a corresponding positioning by pivoting by means of a securing element made as a fastening nut 72 by screwing on the latter. The securing nut 72 is also shaped such that it matches the spherical arching of the securing element 62. The light barrier holder can be fixed in the desired position by tightening the fastening nut 72.

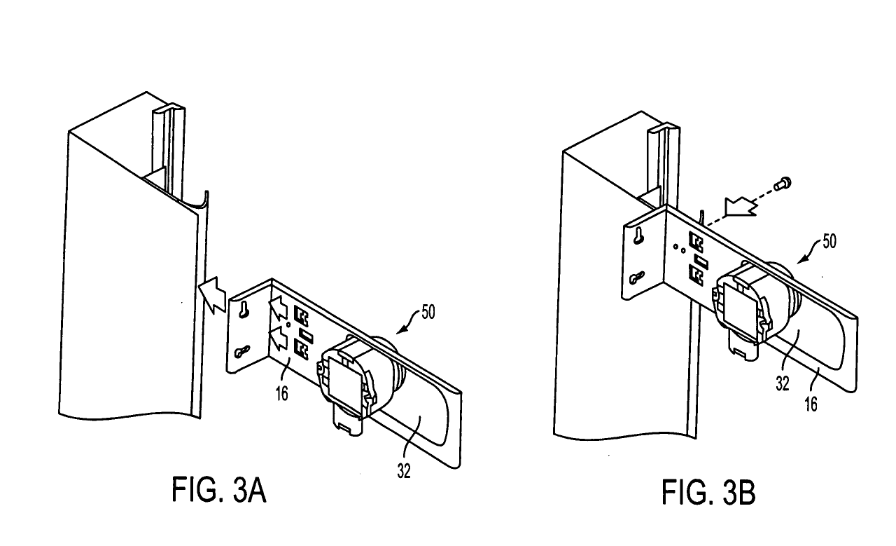

The light barrier holder is shown in a respectively different perspective representation in the installed state in FIGS. 3 a and 3 b.

The embodiment variant illustrated here shows that the installation bracket 16 is arranged between the two installation elements 60 and 62. A fixing in position with a changed distance along the rectangular opening 32 in the installation bracket 16 as well as an alignment of the optical axis “transmitter-receiver” with an all-round pivot possibility of the spherically made housing can take place by a corresponding handling.

The possibility is not shown in the embodiments shown here that the light barrier housing 50 is installed in a commercially available concealed box. The light barrier is here clamped to a smooth-surfaced closing panel which is mounted on the concealed box. The accommodation of the light barrier would also be possible in a door pillar which can be used, for example, with sliding courtyard gates or pivoting courtyard gates. In an installation variant of this type, the light barrier can be installed in corresponding bores directly in the pillar while utilizing the pivot possibility due to the spherical geometry.

Where the installation of the light barrier in conjunction with an installation bracket or in a concealed manner in a wall or inside a door pillar is not possible, a further installation type on plaster can be carried out in most varied housings. An additional moisture protection is furthermore given by this housing which is required for the installation in the outside area.

1. A light barrier holder comprising a receiving housing for the reception of a part of the light barrier, said part having an opening through which rays of the light barrier can pass, wherein a surface of the housing is arched in the manner of a spherical surface in a region of the opening; and wherein a tubular neck is set at the housing in the region of the opening, said neck being able to be plugged through corresponding openings of installation elements each having a corresponding spherical arching and being able to be fixed by a securing element.

2. The light barrier holder according to claim 1, wherein the tubular neck has an external thread; and wherein the securing element is a fastening nut which can be screwed onto the external thread of the tubular neck.

3. The light barrier holder according to claim 1, wherein the housing and the part are comprised of plastic.

4. The light barrier holder according to claim 1, wherein the installation elements include disk-shaped or plate-shaped elements.

5. The light barrier holder according to claim 1, wherein two installation elements are used.

6. The light barrier holder according to claim 5, wherein the two installation elements can be clipped to one another.

7. The light barrier holder according to claim 1, wherein the installation elements are arranged at both sides of an elongate cut-out of an installation bracket.

8. The light barrier holder according to claim 1, wherein the installation element with the corresponding spherical arching is part of an installation housing, and where the corresponding spherical archings have a matching shape.

9. The light barrier holder according to claim 1, wherein the installation element with the corresponding spherical arching is part of a door pillar.

10. The light barrier holder according to claim 1 wherein said part includes at least one of a transmitter and a receiver.

11. A light barrier holder comprising:
a receiving housing adapted for the reception of a transmitter or receiver of the light barrier, said transmitter or receiver having an opening through which rays of the light barrier can pass, the housing having an arched spherical surface in a region of the opening, the housing further having a tubular neck in the region of the opening, said neck configured to be plugged through corresponding openings of installation elements each having a corresponding spherical arching and configured to be fixed by a securing element, wherein the spherical surface is further adapted to enable the receiving housing to be pivoted with respect to the installation elements before being secured by the securing element or after the release of the securing element.

12. The light barrier holder according to claim 11, wherein the tubular neck has an external thread; and wherein the securing element is a fastening nut which can be screwed onto the external thread of the tubular neck.

13. The light barrier holder according to claim 11, wherein the housing and the part are comprised of plastic, and the holder is further adapted to fix the housing in a desired position.

14. The light barrier holder according to claim 13, wherein the installation elements include disk-shaped or plate-shaped elements.

15. The light barrier holder according to claim 14, wherein two installation elements are used.

16. The light barrier holder according to claim 15, wherein the two installation elements can be clipped to one another.

17. The light barrier holder according to claim 15, wherein the installation elements are arranged at both sides of an elongate cut-out of an installation bracket.

18. The light barrier holder according to claim 15, wherein the installation element with the corresponding spherical arching is part of an installation housing, and where the corresponding spherical archings have a matching shape.

19. The light barrier holder according to claim 15, wherein the installation element with the corresponding spherical arching is part of a door pillar.

20. The light barrier holder according to claim 15, wherein said part includes at least one of a transmitter and a receiver.
